(19) United States
(12) Patent Application Publication
(10) Pub. No.: US 2005/0233103 A1
(43) Pub. Date: Oct. 20, 2005

(54) Composition for hard coat, surface protecting film, and optical disc

(75) Inventors: Masashi Enomoto, Tokyo (JP); Rie Tsubo, Miyagi (JP); Minoru Kikuchi, Miyagi (JP); Kazuhiro Mori, Miyagi (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: Sony Corporation, Tokyo (JP)

(21) Appl. No.: 11/071,231

(22) Filed: Mar. 4, 2005

(30) Foreign Application Priority Data
Mar. 9, 2004 (JP) 2004-066433

(51) Int. Cl. B32B 3/02

(52) U.S. Cl. 428/64.4

(57) ABSTRACT

The present invention realizes forming of a hard coat having excellent leveling without lowering physical properties. An information signal portion is formed on a substrate. A light transmitting sheet is bonded to the substrate with a bonding layer disposed therebetween to form a light transmitting layer. There is obtained a composition for hard coat by adding a low molecular-weight reactive diluent to a solvent-type hard coat agent. The composition for hard coat is coated on the light transmitting layer uniformly by a spin coating method. The coated composition for hard coat is cured to be a hard coat.

### CROSS REFERENCES TO RELATED APPLICATIONS

The present document is based on Japanese Priority Document JP 2004-066433, filed in the Japanese Patent Office on Mar. 9, 2004, the entire contents of which being incorporated herein by reference.

### BACKGROUND OF THE INVENTION

1. Field of the Invention

The present invention relates to a composition for hard coat, a surface protecting film, and an optical disc, which can improve leveling.

2. Description of Related Art

In recent years, there has been proposed a high-density optical disc comprising a reflective film or a recording layer, and a light transmitting layer, which are stacked on one another on a substrate. The light transmitting layer in the optical disc is formed by stacking a protecting film, such as a polycarbonate film (hereinafter, referred to as “PC film”), on the reflective layer or recording layer. Recording/reproduction of an information signal on the optical disc is made by converging a laser by means of an objective lens having a high NA and irradiating the reflective film or recording layer with the converged laser from the side of the light transmitting layer.

In the above optical disc, considering the increase of the recording density and the reduced thickness of the light transmitting layer, it is important to suppress a surface defect caused during the production and use of the disc. Therefore, a method in which a hard coat is formed on the light transmitting layer to impart a stain resistance or a mar resistance to the optical disc has been proposed (see, for example, patent document 1).

In addition, in the above optical disc, the improvement of the mar resistance is especially important, and therefore, for enhancing the hardness of the film, a method in which the hard coat is formed using a hard coat agent having dispersed therein inorganic fine particles (e.g., silica fine particles) in a high content has been proposed. For further improving the hardness of the hard coat, a method in which a high molecular-weight polymer is used as a base resin component to increase the crosslink density of the hard coat at the time of being cured has been proposed.

[Patent document 1] Unexamined Japanese Patent Application Laid-Open Specification No. Hei 10-110118

### SUMMARY OF THE INVENTION

However, in a case where the inorganic fine particle content is increased or the high molecular-weight polymer is used, the viscosity of the coating composition is disadvantageously increased. The hard coat agent having an increased viscosity is poor in leveling and, when such a hard coat agent is applied to a protecting film, such as a PC film, a problem occurs in that the effect of fine defects of the protecting film surface is further marked.

For solving the problem, a method in which the use of a non-solvent type hard coat agent using a low molecular-weight reactive monomer makes the viscosity of the coating composition low without using a solvent has been proposed. However, this method has problems in that it is difficult to increase the content of inorganic fine particles in the composition, and that the crosslink density is low, as compared to that obtained in the method in which a polymer is crosslinked, and thus the physical properties of the film are poor.

Accordingly, a task of the present invention is to provide a composition for hard coat, which can improve the leveling without sacrificing the physical properties of the film, a surface protecting film, and an optical disc.

For solving the above problems, the first invention is directed to a composition for hard coat, obtained by adding a low molecular-weight reactive diluent to a solvent-type hard coat agent.

The second invention is directed to a surface protecting film having a hard coat obtained by adding a low molecular-weight reactive diluent to a solvent-type hard coat agent, and applying the resultant composition and then curing it.

The third invention is directed to an optical disc which includes: an information signal portion formed on one principal surface of a substrate; a protecting layer formed on the information signal portion; and a surface protecting film formed on at least one surface selected from the protecting layer and the substrate, in which the surface protecting film has a hard coat obtained by adding a low molecular-weight reactive diluent to a solvent-type hard coat agent, and applying the resultant composition and then curing it.

In the present invention, the low molecular-weight reactive diluent is added to the solvent-type hard coat agent and the resultant composition is applied and then cured, and therefore, a hard coat having excellent leveling can be formed without lowering physical properties, such as a friction coefficient and a water contact angle.

As mentioned above, by the present invention, a hard coat having excellent leveling can be formed without lowering physical properties, such as a friction coefficient and a water contact angle. Thus, a high-quality hard coat can be provided.

### BRIEF DESCRIPTION OF THE DRAWINGS

FIG. 1 is a cross-sectional view showing one example of the construction of an optical disc according to a first embodiment of the present invention.

FIG. 2 is a cross-sectional view for explaining one example of the method for producing the optical disc according to the first embodiment of the present invention.

FIG. 3 is a cross-sectional view showing one example of the construction of an optical disc according to a second embodiment of the present invention.

FIG. 4 is a cross-sectional view for explaining one example of the method for producing the optical disc according to the second embodiment of the present invention.

FIG. 5 is a graph showing SER characteristics of the optical disc in Example 1.

FIG. 6 is a graph showing the SER characteristics of the optical disc in Example 2.

FIG. 7 is a graph showing the SER characteristics of the optical disc in Example 3.

FIG. 8 is a graph showing the SER characteristics of the optical disc in Example 4.

FIG. 9 is a graph showing the SER characteristics of the optical disc in Comparative Example 1.

FIG. 10 is a graph showing the SER characteristics of the optical disc in Example 5.

FIG. 11 is a graph showing the SER characteristics of the optical disc in Comparative Example 2.

FIG. 12 is a graph showing evaluation results of a water contact angle with respect to the optical discs 1 in Example 6 and Comparative Examples 2 and 3.

FIG. 13 is a graph showing evaluation results of a friction coefficient with respect to the optical discs 1 in Example 6 and Comparative Examples 2 and 3.

FIG. 14 is a graph showing measurement results of the water contact angle with respect to the optical discs 1 in Examples 7 to 9 and Comparative Examples 4 to 12.

FIG. 15 is a graph showing measurement results of the friction coefficient with respect to the optical discs 1 in Examples 7 to 9 and Comparative Examples 4 to 12.

### DESCRIPTION OF PREFERRED EMBODIMENTS

Hereinbelow, the embodiments of the present invention will be described with reference to the drawings. In all the drawings in connection with the following embodiments, similar parts or portions are indicated by same reference numerals.

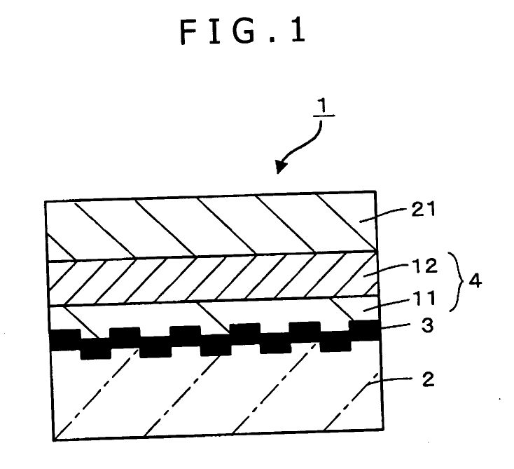

FIG. 1 is a cross-sectional view showing one structural example of an optical disc 1 according to the first embodiment of the present invention. As shown in FIG. 1, the optical disc 1 has a construction in which an information signal portion 3, a light transmitting layer 4 as a protecting layer having light transmission properties, and a hard coat 21 as a surface protecting film are stacked on one another on one principal surface of a substrate 2. In the optical disc 1 according to the first embodiment, recording and/or reproduction of an information signal is made by irradiating the information signal portion 3 with a laser from the side of the light transmitting layer 4. The recording and/or reproduction of an information signal is made by converging a laser having a wavelength in the range of, for example, 400 nm to 410 nm by means of an optic having a numerical aperture in a range of from 0.84 to 0.86, and irradiating the information signal portion 3 with the converged laser from the side of the light transmitting layer 4. As an example of the optical disc 1, there can be mentioned a Blu-ray disc.

The substrate 2 has an annular form having a center hole (not shown) in the center. In the one principal surface of the substrate 2 on which the information signal portion 3 is formed, a pre-embossed pattern is formed as a pregroove for guiding an optical spot used for the recording and/or reproduction of information. By using the pregroove as a guide, a laser can move to an arbitrary position on the optical disc 1. Examples of forms of the pregroove include various forms, such as a spiral form, a concentric circle form, and a pit row. The diameter of the substrate 2 is selected to be, for example, 120 mm. From the viewpoint of obtaining rigidity, the thickness of the substrate 2 is preferably selected from 0.3 to 1.3 mm, more preferably 0.6 mm to 1.3 mm, and, for example, selected to be 1.1 mm.

As a material for the substrate 2, a plastic material, such as a polycarbonate resin, a polyolefin resin, or an acrylic resin, or glass is used. From a viewpoint of cost reduction, it is preferred to use a plastic material as a material for the substrate 2.

The information signal portion 3 has a construction appropriately selected depending on the type of the optical disc 1. Specifically, in a case where the optical disc 1 is a read-only optical disc, the information signal portion 3 is a reflective film. Examples of materials for the reflective film include metal elements, semi-metal elements, and compounds and mixtures thereof, more specifically, simple substances, such as Al, Ag, Au, Ni, Cr, Ti, Pd, Co, Si, Ta, W, Mo, and Ge, and alloys having the above simple substance as their main components. Of these, from a practical point of view, it is preferred to use an Al, Ag, Au, Si, or Ge material. On the other hand, in a case where the optical disc 1 is a write-once read-multiple or rewritable optical disc, the information signal portion 3 is a recording layer. Examples of write-once read multiple recording layers include a recording layer comprising a reflective film and an organic dye material stacked on one another on the substrate 2. Examples of rewritable recording layers include a recording layer comprising a reflective film, a lower dielectric layer, a phase change recording layer, and an upper dielectric layer, which are stacked on one another on the substrate 2.

The light transmitting layer 4 comprises a light transmitting sheet (film) 12 having a planar annular form, and a bonding layer 11 for bonding the light transmitting sheet 12 to the substrate 2 having the information signal portion 3 formed thereon. The bonding layer 11 is comprised of, for example, an ultraviolet curable resin or a pressure sensitive adhesive (PSA). The thickness of the light transmitting layer 4 is preferably selected to be 10 μm to 177 μm considering the use of a red laser to a blue laser.

It is preferred that the light transmitting sheet 12 is comprised of a material having a poor absorption power with regard to the laser used for recording and/or reproduction, and, specifically, it is preferably comprised of a material having a transmittance of 90% or higher. Examples of materials for the light transmitting sheet 12 include polycarbonate resin materials and polyolefin resins (e.g., ZEONEX (registered trademark, manufactured by Zeon Corporation)).

The thickness of the light transmitting sheet 12 is preferably selected to be 0.3 mm or less, more preferably selected from the range of from 3 μm to 177 μm. For example, the thickness of the light transmitting sheet 12 is selected so that the total thickness of the light transmitting sheet 12 and the bonding layer 11 is, for example, 100 μm. The combination of the light transmitting layer 4 having such a small thickness and an objective lens having an NA as high as about 0.85 realizes high-density recording.

The hard coat 21 is obtained by adding a low molecular-weight reactive diluent to a solvent-type hard coat agent, and applying the resultant composition to the light transmitting layer 4 and then curing it. The reactive diluent is a polymerizable monomer, and the functional group is appropriately selected depending on the type of the polymerization. Generally, the lower the molecular weight, the lower the viscosity, but there is a problem in that the unreacted monomer remains in the film or that the volume shrinkage is relatively large, and therefore, when the physical properties are especially important, it is preferred that a monomer having a slightly higher molecular weight, i.e., molecular weight in the oligomer region (macromer) is used.

The reactive diluent comprises, for example, a monomer, an oligomer, a polymer, a solvent, a photoinitiator, and an additive. Examples of monomers include acrylic monomers, methacrylic monomers, styrene monomers, and vinyl monomers. Examples of oligomers include acrylic oligomers. Examples of solvents include 2-methoxypropanol.

Examples of polymerization initiators include ketone, benzoin, and thioxane photoinitiators. Examples of ketone initiators include acetophenone and benzophenone. Examples of benzoin initiators include benzoin and benzoin methyl ether. Examples of thioxane initiators include thioxane and 2-methylthioxane.

As examples of acrylic monomers, there can be mentioned the following types. Examples of acrylic monomers having no functional group at the side chain include methyl acrylate, ethyl acrylate, butyl acrylate, isobutyl acrylate, t-butyl acrylate, benzyl acrylate, cyclohexyl acrylate, 2-ethylhexyl acrylate, cetyl acrylate, lauryl acrylate, n-stearyl acrylate, isobornyl acrylate, 2-methoxyethyl acrylate, 3-methoxybutyl acrylate, ethoxydiethylene glycol acrylate, caprolactone-modified tetrahydrofurfuryl acrylate, neopentyl glycol caprolactone-modified hydroxypivalate diacrylate, and tetrahydrofurfuryl acrylate.

Examples of acrylic monomers having a plurality of double bonds per one molecule include ethylene glycol diacrylate, diethylene glycol diacrylate, 1,4-butanediol diacrylate, 1,6-hexanediol diacrylate, tripropylene grlycol diacrylate, trimethylolpropane triacrylate, trimethylolpropane EO-modified triacrylate, pentaerythritol triacrylate, neopentyl glycol hydroxypivalate diacrylate, 1,9-nonanediol acrylate, dipentaerythritol pentaacrylate, dipentaerythritol hexaacrylate, acrylic modified dipentaerythritol acrylate, EO-modified bisphenol A diacrylate, ε-caprolactone-modified dipentaerythritol acrylate, and (2≡{1,1-dimethyl-2-[(1-oxo-2-propenyl)oxy]ethyl}-5-ethyl-1,3-dioxane-5-yl) methyl 2-propenoate.

Examples of acrylic monomers having a hydroxyl group at the side chain include 2-hydroxyethyl acrylate, 2-hydroxypropyl acrylate, and 4-hydroxybutyl acrylate.

Examples of acrylic monomers having an acidic group at the side chain include an addition product of phthalic anhydride and 2-hydroxypropyl acrylate.

Examples of acrylic monomers having a basic group at the side chain include 2-dimethylaminoethyl acrylate and 2-diethylaminoethyl acrylate.

Examples of acrylic monomers having an epoxy group at the side chain include glycidyl acrylate.

Examples of acrylic monomers having an ionic group at the side chain include N,N,N-trimethyl-N-(2-hydroxy-3-acryloyloxypropyl)ammonium chloride.

The acrylic monomer is not limited to the above examples, and, for example, N,N-dimethylacrylamide, acrylonitrile, acrylamide, dimethylaminopropylmethacrylamide, diacetone acrylamide, N,N-dimethylaminopropylacrylamide, or N,N≡-dimethylacrylamide can be used.

As the methacrylic monomer, for example, one obtained by replacing an acrylic group in the above acrylic monomer with a methacrylic group can be used.

As the styrene monomer, for example, styrene, divinylbenzene, p-t-butoxystyrene, p-acetoxystyrene, p-(1-ethoxy)styrene, 2-t-butoxy-6-vinylnaphthalene, p-chlorostyrene, or sodium p-styrenesulfonate can be used.

Further, vinyl acetate, vinyl chloride, 4-hydroxybutyl vinyl ether, diethylene glycol monovinyl ether, or N-vinyl-2-pyrrolidone can be used.

Examples of solvent-type hard coat agents include a radical polymerization-type ultraviolet curable resin, an ultraviolet curable resin containing colloidal silica coated with an organic substance for enhancing the hardness, and an ultraviolet curable resin having improved antistatic properties.

The ultraviolet curable resin may be comprised of, for example, a monofunctional or multifunctional monomer, a polymerization initiator, and an additive. Examples of monomers include acrylic monomers, and examples of acrylic monomers include those mentioned above in connection with the reactive diluent. Examples of polymerization initiators include those mentioned above in connection with the reactive diluent.

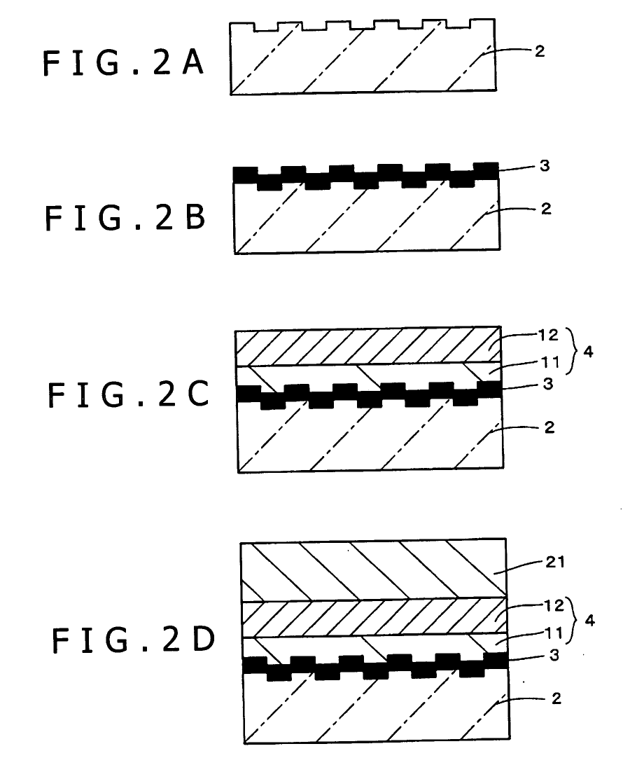

Next, one example of the method for producing the optical disc 1 according to the first embodiment of the present invention will be described. FIG. 2 is a cross-sectional view for explaining one example of the method for producing the optical disc 1 according to the first embodiment.

First, as shown in FIG. 2A, a substrate 2 having asperities on a principal surface is formed by, e.g., an injection molding method. Then, as shown in FIG. 2B, an information signal portion 3 is formed on the pre-embossed pattern of the substrate 2 by, e.g., a sputtering method.

Then, a light transmitting sheet 12 having a planar annular form is bonded through a bonding layer 11 to the substrate 2 on the side on which the information signal portion 3 is formed. Thus, as shown in FIG. 2C, a light transmitting layer 4 is formed so that it covers the information signal portion 3 formed on the substrate 2.

Next, a low molecular-weight reactive diluent is added to a solvent-type hard coat agent to obtain a composition for hard coat. It is preferred that the content of the reactive diluent in the composition is in a range of from 10% to 30% by weight. When the content is less than 10% by weight, the SER (signal error rate) characteristics tend to deteriorate, and, when the content is more than 30% by weight, the surface of the hard coat 21 is likely to have asperities, increasing the tracking error.

Then, as shown in FIG. 2D, the composition for hard coat is applied to the light transmitting layer 4 and then cured to form a hard coat 21. Examples of methods for applying the composition for hard coat include a spin coating method, a gravure coating method, and a spray coating method, and, from a viewpoint of forming the highly uniform hard coat 21, preferred is a spin coating method. As an example of the method for curing the composition for hard coat, there can be mentioned an ultraviolet curing method.

In the first embodiment of the present invention, the following effects can be obtained.

The low molecular-weight reactive diluent is added to the solvent-type hard coat agent to obtain a composition for hard coat, and the composition for hard coat obtained is applied to the light transmitting layer 4 and then cured to form the hard coat 21. Therefore, the hard coat 21 having excellent leveling can be formed on the light transmitting layer 4 without lowering physical properties of the film, such as a friction coefficient and a water contact angle. Thus, the tracking error can be reduced. Further, the SER characteristics can be improved.

Next, the second embodiment of the present invention will be described. In the first embodiment, an example in which the hard coat 21 is formed on the signal surface of the optical disc 1 is shown, and, in the second embodiment, an example in which a hard coat, a coupling agent layer, and a stain-proofing layer are formed on the signal surface is described.

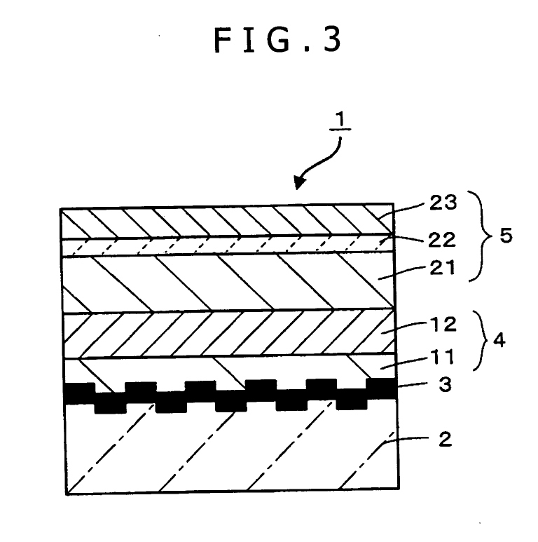

FIG. 3 is a cross-sectional view showing one example of the construction of an optical disc 1 according to the second embodiment of the present invention. As shown in FIG. 3, the optical disc 1 has a construction in which an information signal portion 3, a light transmitting layer 4, and a surface protecting film 5 are stacked on one another on one principal surface of a substrate 2. The surface protecting film 5 comprises a hard coat 21, a coupling agent layer 22, and a stain-proofing layer 23, which are stacked on one another on the light transmitting layer 4.

The coupling agent layer 22 is comprised of a compound which has per one molecule two types of functional groups having different reactivity, and which is represented by the following general formula (1):
X—Rₐ—Si(OR_{b})₃ (1)
where X represents a reactive end group (such as a vinyl group, an epoxy group, an amino group, a methacrylic group, a mercapto group, or an isocyanate group), Rₐ represents an alkylene group, and R_{b} represents an alkyl group.

Specifically, examples of materials constituting the coupling agent layer 22 include silane, titanate, aluminum, and zirco-aluminum coupling agents, and these coupling agents may be used individually or in combination, and can be selected depending on the experiential knowledge, but it is especially preferred to use a silane coupling agent. Of these, preferred is a silane coupling agent in which the alkoxy group at the end is ethoxy. The coupling agent has in its molecule both a reactive group (e.g., an acrylic group, an amino group, or an epoxy group) having a bonding property to the surface component of the hard coat 21 comprised of, for example, an acrylic resin and a reactive group (e.g., a methoxy group or an ethoxy group) having a bonding property to the stain-proofing agent component constituting the stain-proofing layer 23, and can mediate bonding between the hard coat 21 and the stain-proofing layer 23 (coupling) to improve the affinity therebetween.

Specific examples of coupling agents are shown below. Examples of silane coupling agents include acrylic silane coupling agents, such as γ-methacryloyloxypropyltrimethoxysilane, γ-methacryloyloxypropyltriethoxysilane, γ-methacryloyloxypropylmethyldimethoxysilane, γ-methacryloyloxypropylmethyldiethoxysilane, γ-acryloyloxypropyltrimethoxysilane, and γ-acryloyloxypropylmethyldimethoxysilane.

Examples of amino silane coupling agents include γ-aminopropyltrimethoxysilane, γ-aminopropyltriethoxysilane, γ-aminopropylmethyldimethoxysilane, γ-aminopropylmethyldiethoxysilane, N-phenyl-γ-aminopropyltrimethoxysilane, N-(phenylmethyl)-γ-aminopropyltrimethoxysilane, N-methyl-γ-aminopropyltrimethoxysilane, N,N,N-trimethyl-γ-aminopropyltrimethoxysilane, N,N,N-tributyl-γ-aminopropyltrimethoxysilane, N-β(aminoethyl)γ-aminopropyltrimethoxysilane, N-β(aminoethyl)γ-aminopropylmethyldimethoxysilane, N-β(aminoethyl)γ-aminopropyltriethoxysilane, N-ω(aminohexyl)γ-aminopropyltrimethoxysilane, and N[N′-β(aminoethyl)]-β(aminoethyl)γ-aminopropyltrimethoxysilane.

Examples of epoxy silane coupling agents include β-(3,4-epoxycyclohexyl)ethyltrimethoxysilane, γ-glycidoxypropyltrimethoxysilane, γ-glycidoxypropyltriethoxysilane, γ-glycidoxypropylmethyldiethoxysilane, and γ-glycidoxypropylmethyldimethoxysilane.

Examples of titanate coupling agents include isopropyltriisostearoyl titanate, isopropyltridodecylbenzenesulfonyl titanate, isopropyl tris(dioctylpyrophosphate) titanate, tetraoctyl bis(di-tridecylphosphite) titanate, tetraisopropyl bis(dioctylphosphite) titanate, tetra(2,2-diallyloxymethyl-1-butyl) bis(di-tridecyl)phosphite titanate, bis(dioctylpyrophosphate)oxyacetate titanate, bis(dioctylpyrophosphate)ethylene titanate, isopropyltrioctanoyl titanate, isopropyldimethacrylisostearoyl titanate, isopropylisostearoyldiacryl titanate, isopropyl tri(dioctyl phosphate) titanate, isopropyltricumylphenyl titanate, isopropyltri(N-aminoethyl-aminoethyl) titanate, dicumyl phenyloxyacetate titanate, and diisostearoylethylene titanate.

The thickness of the coupling agent layer 22 is preferably in the range of from 0.1 nm to 100 μm, further preferably 0.1 nm to 1 μm. In a case where the thickness is smaller than 0.1 nm, the coupling agent layer cannot mediate bonding between the hard coat and the fluorine stain-proofing layer to improve the affinity therebetween. If the thickness is larger than 100 μm, it is likely that a crack is caused in the coupling agent layer.

The stain-proofing layer 23 is comprised of a fluorine resin. The fluorine resin is an alkoxysilane compound having a perfluoropolyether group or a fluoroalkyl group.

The alkoxysilane compound having a perfluoropolyether group or a fluoroalkyl group has low surface energy, and hence exhibits excellent stain-proofing and water-repellent effects, and exhibits a lubricating effect due to the perfluoropolyether group contained.

The stain-proofing layer 23 contains, for example, an alkoxysilane compound having a perfluoropolyether group and being represented by the following general formula (2) or (3), or an alkoxysilane compound having a fluoroalkyl group and being represented by the following general formula (4) or (5).
(R³O)₃Si—R²—R¹CO—Rf—COR¹—R²—Si(OR³)₃ (2)
where Rf represents a perfluoropolyether group, R¹ represents a divalent atom or group (e.g., any one of O, NH, and S), R² represents an alkylene group, and R³ represents an alkyl group.
   RfCOR¹—R²—Si(OR³)₃ (3)
where Rf represents a perfluoropolyether group, R¹ represents any one of O, NH, and S, R² represents an alkylene group, and R³ represents an alkyl group.
   Rf′—R¹—R²—Si(OR³)₃ (4)
where Rf′ represents a fluoroalkyl group, R¹ represents a divalent atom or atomic group, R² represents an alkylene group, and R³ represents an alkyl group.
   Rf′—R¹—Si—(OR²)₃ (5)
wherein Rf′ represents a fluoroalkyl group, R¹ represents an alkyl group having less than 7 carbon atoms, and R² represents an alkyl group.

With respect to the molecular structure of the perfluoropolyether group indicated by Rf in the general formula (2), there is no particular limitation, and perfluoropolyether groups having a variety of chain lengths are included, but preferred is a perfluoropolyether group having the molecular structure shown below.
—CF₂— (OC₂F₄)ₚ—(OCF₂)_{q}—OCF2 (6)

In the perfluoropolyether group represented by the general formula (6), it is preferred that each of p and q falls in a range of from 1 to 50.

With respect to the molecular weight of the alkoxysilane compound having a perfluoropolyether group represented by the general formula (6), there is no particular limitation, but, from a viewpoint of achieving excellent stability and handling properties, it is preferred to use the alkoxysilane compound having a number average molecular weight of 400 to 10,000, more preferably 500 to 4,000.

In the alkoxysilane compound having a perfluoropolyether group represented by the general formula (6), R¹ represents a divalent atom or group, which is a group for bonding R² to the perfluoropolyether group, and there is no particular limitation, but, from a viewpoint of the synthesis, it is preferred that R¹ is an atom other than carbon or an atomic group, such as O, NH, or S. R² is a hydrocarbon group and preferably has 2 to 10 carbon atoms. Examples of R²'s include alkylene groups, such as a methylene group, an ethylene group, and a propylene group, and a phenylene group.

In the alkoxysilane compound having a perfluoropolyether group represented by the general formula (6), R³ is an alkyl group constituting an alkoxy group, and generally has 3 or less carbon atoms, specifically, for example, an isopropyl group, a propyl group, an ethyl group, or a methyl group, but it may have more than 3 carbon atoms.

In the stain-proofing layer 23, with respect to the molecular structure of the perfluoropolyether group indicated by Rf in the general formula (3), there is no particular limitation, and perfluoropolyether groups having a variety of chain lengths are included, but preferred are perfluoropolyether groups having the molecular structures shown below.

Rf is a group obtained by replacing a hydrogen atom in an alkyl group with a fluorine atom, and examples of Rf's include groups represented by the chemical formulae (7) to (9) below. All the hydrogen atoms in an alkyl group are not required to be replaced with fluorine atoms, and hydrogen may be partially contained.
F(CF₂CF₂CF₂)ₙ (7)
where n is an integer of 1 or more.
   CF₃(OCF(CF₃)CF₂)ₘ(OCF₂)₁ (8)
where each of 1 and m is an integer of 1 or more.
   F—(CF(CF₃)CF₂)ₖ— (9)
where k is an integer of 1 or more.

In the compound (8), it is preferred that m/l falls in a range of from 0.5 to 2.0.

With respect to the molecular weight of the alkoxysilane compound having a perfluoropolyether group, there is no particular limitation, but, from the viewpoint of achieving excellent stability and handling properties, it is preferred to use the alkoxysilane compound having a number average molecular weight of 400 to 10,000, more preferably 500 to 4,000.

With respect to the molecular structure of the fluoroalkyl group indicated by Rf′, there is no particular limitation, and examples include groups obtained by replacing a hydrogen atom in an alkyl group with a fluorine atom, and fluoroalkyl groups having a variety of chain lengths and a variety of fluorine replacement degrees are included, but preferred are fluoroalkyl groups having the molecular structures shown below.
F(CF₂)ₛ(CH₂)ₜ (10)
—(CH₂)ₜ(CF₂)ₛ(CH₂)ₜ— (11)
where s is an integer of 6 to 12, and t is an integer of 20 or less.

With respect to the thickness of the stain-proofing layer 23 comprised of the compound, there is no particular limitation, but, from a viewpoint of achieving excellent balance between the water repellency, the stain resistance, and the application properties and high surface hardness, it is preferred that the thickness is 0.5 nm to 100 nm.

As the stain-proofing agent containing a perfluoropolyether group, a material known by those skilled in the art can be employed. Examples of the materials include perfluoropolyether having a polar group at the end (see Unexamined Japanese Patent Application Laid-Open Specification No. Hei 9-127307), a stain-proofing film-forming composition containing an alkoxysilane compound having a perfluoropolyether group having a specific structure (see Unexamined Japanese Patent Application Laid-Open Specification No. Hei 9-255919), and a surface modifier obtained by combining an alkoxysilane compound having a perfluoropolyether group with another material (see Unexamined Japanese Patent Application Laid-Open Specification Nos. Hei 9-326240, Hei 10-26701, Hei 10-120442, and Hei 10-148701).

Generally, a base material can be lowered in surface energy by applying an organic fluorine compound to the surface of the base material. However, a satisfactory effect cannot be obtained by merely applying the organic fluorine compound. In other words, an organic compound having such a good balance of a polar group and a hydrophobic group that the molecules are oriented is needed. The affinity of the compound with the base material cannot be easily known.

The construction of the optical disc 1 except for the above-mentioned construction is similar to that in the first embodiment, and hence the description therefor is omitted.

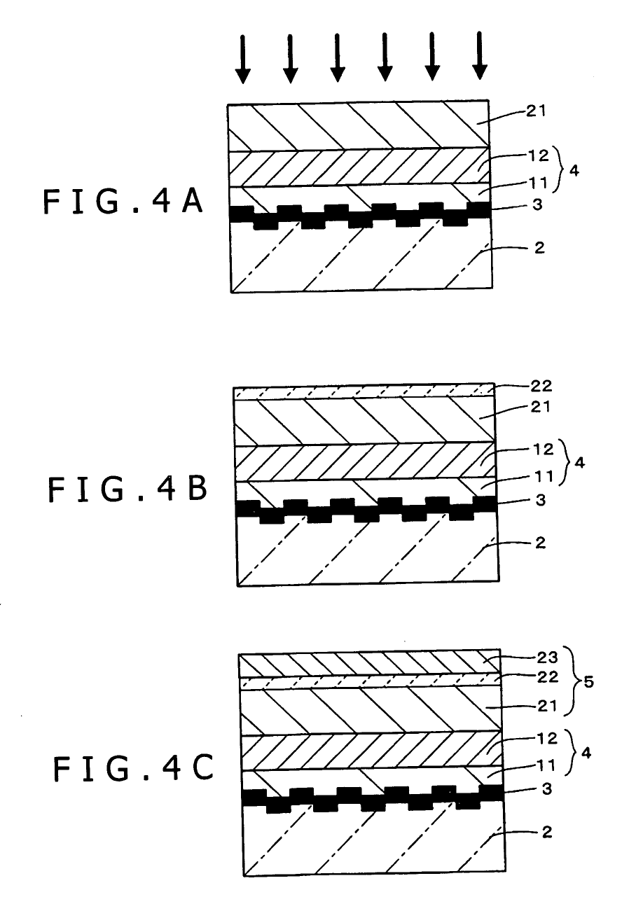

Next, one example of the method for producing the optical disc 1 according to the second embodiment of the present invention will be described. FIG. 4 is a cross-sectional view for explaining one example of the method for producing the optical disc 1 according to the second embodiment. The steps of from the first to the step for forming the hard coat 21 are similar to those in the first embodiment, and hence the description therefor with reference to the drawings is omitted.

Then, as shown in FIG. 4A, a substrate 2 having a hard coat 21 formed thereon is placed in an oxygen plasma asher, and the oxygen plasma asher is evacuated and the hard coat 21 is subjected to oxygen plasma treatment for a predetermined period of time, for example, 15 to 60 seconds. In a case where the hard coat 21 contains silica fine particles, the organic component of the hard coat 21 is etched by the oxygen plasma treatment, so that the silica fine particles appear. Here is shown an example in which the oxygen plasma treatment is conducted under a reduced pressure by a reduced pressure plasma system, but the oxygen plasma treatment may be conducted under atmospheric pressure by an atmospheric pressure plasma system.

Next, as shown in FIG. 4B, a coupling agent layer 22 is formed on the hard coat 21. Examples of methods for forming the coupling agent layer 22 include a method in which the hard coat 21 is exposed to vapor of a coupling agent, a method in which a coupling agent is diluted with a solvent and applied to the hard coat 21, and a method in which a stock solution of a coupling agent is applied to the hard coat 21, and preferred is a method in which the hard coat 21 is exposed to vapor of a coupling agent. In the method in which a coupling agent is diluted with a solvent and applied to the hard coat 21 and the method in which a stock solution of a coupling agent is applied to the hard coat 21, problems are caused in that an impurity derived from the solvent is mixed into the layer, that the coupling agent deteriorates due to a reaction with water contained in the solvent, and that the coupling agent deteriorates (changes into an oligomer) and is applied to the hard coat 21 to lower the surface uniformity.

The method for forming the coupling agent layer 22 is not limited to the above examples. Other examples include a method in which the surface of the hard coat 21 is rubbed by a coupling agent solution, a method in which the surface of the hard coat 21 is sprayed with a coupling agent solution, and a method in which the hard coat 21 is dipped in a coupling agent solution. Examples of methods in which the surface of the hard coat 21 is rubbed by a coupling agent solution include a method in which physical mechanical force is applied to the surface of the hard coat 21 in the presence of a coupling agent solution, specifically, a method in which the surface of the hard coat is rubbed (or wiped) by cloth impregnated with a coupling agent solution, a method in which the surface of the hard coat 21 is rubbed in a coupling agent solution, and a method in which the surface of the hard coat 21 having a coupling agent solution thereon is rubbed.

In a case where the coupling agent is used in the form of a solution in a solvent, examples of solvents include alcohol solvents, such as methanol, ethanol, propanol, isopropanol, 2-methoxypropanol, butyl cellosolve, and solmix as mixed solvents thereof; ketone solvents, such as acetone, MEK, 2-pentanone, and 3-pentanone; and aromatic hydrocarbon solvents, such as toluene and xylene. These solvents may be used individually or in combination, and may be mixed with water. Especially preferred is butyl cellosolve.

Next, as shown in FIG. 4C, a stain-proofing layer 23 is formed on the coupling agent layer 22. As an example of the method for forming the stain-proofing layer 23, there can be mentioned a method in which a stain-proofing agent containing an alkoxysilane compound having a perfluoropolyether group and being represented by the formula (1) or (2), or an alkoxysilane compound having a fluoroalkyl group and being represented by the formula (3) or (4) is diluted with a solvent and the resultant solution is applied to the coupling agent layer 22 and dried, followed by curing. Examples of methods for applying the stain-proofing agent include a coating method using a gravure coater, a dipping method, a spray coating method, a spin coating method, a rubbing coating method, and a vacuum method.

With respect to the solvent used for diluting the alkoxysilane compound, there is no particular limitation, but the solvent to be used is selected considering the stability of the composition, the wettability of the uppermost surface layer to be coated, and the volatility of the solvent, and, for example, a fluorinated hydrocarbon solvent is used. The fluorinated hydrocarbon solvent is a compound obtained by replacing by fluorine atoms part of or all the hydrogen atoms in a hydrocarbon solvent, such as an aliphatic hydrocarbon, a cyclic hydrocarbon, or an ether. Examples include ZEORORA-HXE (trade name) (boiling point: 78° C.), manufactured and sold by Zeon Corporation; perfluoroheptane (boiling point: 80° C.); perfluorooctane (boiling point: 102° C.); hydrofluoropolyether, such as H-GALDEN-ZV75 (boiling point: 75° C.), H-GALDEN-ZV85 (boiling point: 85° C.), H-GALDEN-ZV100 (boiling point: 95° C.), H-GALDEN-C (boiling point: 130° C.), and H-GALDEN-D (boiling point: 178° C.), and perfluoropolyether, such as SV-110 (boiling point: 110° C.) and SV-135 (boiling point: 135° C.), trade names, manufactured and sold by Ausimont, Inc.; and perfluoroalkane, such as FC series, manufactured and sold by Sumitomo 3M Ltd.

Among these fluorinated hydrocarbon solvents, as a solvent for solving the fluorine compound of the general formula (1), (2), or (3), one having a boiling point in the range of from 70° C. to 240° C. is selected for obtaining an organic film having a uniform thickness without unevenness, and further, hydrofluoropolyether (HFPE) or hydrofluorocarbon (HFC) is selected and these are preferably used individually or in combination. When the boiling point of the solvent is too low, for example, the coating tends to be uneven. On the other hand, when the boiling point is too high, it is likely that the film is not completely dried, so that the coating form is poor. In addition, HFPE or HFC has excellent solubility of the compound represented by the general formula (1), (2), or (3), and hence excellent coated surface can be obtained.

In the second embodiment of the present invention, the following effects can be obtained.

The low molecular-weight reactive diluent is added to the solvent-type hard coat agent to obtain a composition for hard coat, and the composition for hard coat obtained is applied to the light transmitting layer 4 and then cured to form the hard coat 21, and the coupling agent layer 22 is formed on the hard coat 21 and the stain-proofing layer 23 is formed on the coupling agent layer 22. Therefore, not only can the hard coat 21 having excellent leveling be formed on the light transmitting layer 4 without lowering physical properties of the film, such as a friction coefficient and a water contact angle, but also the surface protecting film 5 having both excellent stain resistance and excellent mechanical strength can be formed on the light transmitting layer 4.

Further, in a case where the hard coat 21 is subjected to oxygen plasma treatment and exposed to vapor of a coupling agent to form the coupling agent layer 22 on the hard coat 21 and a stain-proofing agent is applied to the coupling agent layer 22 and cured to form the stain-proofing layer 23, not only can the wettability of the hard coat 21 by the coupling agent be improved by the plasma treatment, but also the surface of the hard coat 21 etched by the plasma treatment can be reinforced by the coupling agent layer 22. Thus, the surface protecting film 5 having both excellent stain resistance and excellent mechanical strength can be formed on the light transmitting layer 4.

Hereinbelow, the present invention will be described in more detail with reference to the following Examples, which should not be construed as limiting the scope of the present invention.

[Examination of Leveling]

First, the leveling was examined by changing the amount of a reactive diluent added to a solvent-type hard coat agent.

### EXAMPLE 1

A reactive diluent was first added in an amount of 5% by weight to a solvent-type hard coat agent to obtain a composition for hard coat. As the solvent-type hard coat agent, one that comprises an acrylic monomer, a polymerization initiator, and an additive was used. As the reactive diluent, one that comprises an acrylic monomer, an acrylic oligomer, a polymer, 2-methoxypropanol, a photoinitiator, and an additive was used.

Then, the above-obtained hard coat composition was uniformly applied to a light transmitting layer 4 by a spin coating method without a stand-by time. In the spin coating, the number of revolutions was 5,000 rpm, and the spin time was 3 seconds. Subsequently, the uniformly applied hard coat composition was cured by ultraviolet light irradiation to obtain a hard coat 21.

### EXAMPLE 2

An optical disc 1 was obtained in substantially the same manner as in Example 1 except that the reactive diluent content was changed to 10% by weight.

### EXAMPLE 3

An optical disc 1 was obtained in substantially the same manner as in Example 1 except that the reactive diluent content was changed to 20% by weight.

### EXAMPLE 4

An optical disc 1 was obtained in substantially the same manner as in Example 1 except that the reactive diluent content was changed to 30% by weight.

### EXAMPLE 5

An optical disc 1 was obtained in substantially the same manner as in Example 1 except that the reactive diluent content was changed to 40% by weight.

### COMPARATIVE EXAMPLE 1

An optical disc was obtained in substantially the same manner as in Example 1 except that a composition for hard coat which comprises solely the solvent-type hard coat agent was used.

Then, with respect to each of the optical discs 1 in Examples 1 to 5 and Comparative Example 1, the following evaluations were conducted.

(a) Evaluation of Surface Roughness of Hard Coat

The surface of the hard coat 21 was observed under an optical microscope.

(b) Evaluation of Tracking Error

Using a drive for Blu-ray disc, a tracking error was measured at r=23 mm. The tracking error standard is 9 nm.

(c) Evaluation of SER (Signal Error Rate)

Using a drive for Blu-ray disc, an SER was measured. Measurement area: Entire surface at r=24 mm to 58 mm; 100 RUB (recording unit block) recording-reproduction/2900 RUB skip (Namely, 1/30 of the whole data region was measured.)

The results of the evaluations of hard coat surface roughness, tracking error, and SER with respect to Examples 1 to 5 and Comparative Example 1 are shown in Table 1. In the columns containing the results of the evaluation of hard coat surface roughness, expressions “Excellent”, “Good”, and “Poor” have the following meanings.

Excellent: No uneven surface was found on the hard coat 21.

Good: A slightly roughened surface was recognized on the coated surface at the edge portion, which did not adversely affected the SER characteristics.

Poor: An uneven surface was observed on the hard coat 21.

TABLE 1

| | Reactive | HC surface | Tracking | |
|---|---|---|---|---|
| | diluent | roughness | error | SER |
| Comparative | 0% | Excellent | 4.7 nm | 2.59 × 10⁻⁴ |
| Example 1 | | | | |
| Example 1 | 5% | Excellent | 4.3 nm | 2.11 × 10⁻⁴ |
| Example 2 | 10% | Excellent | 5.8 nm | 2.23 × 10⁻⁵ |
| Example 3 | 20% | Excellent | 7.0 nm | 1.17 × 10⁻⁵ |
| Example 4 | 30% | Good | 8.6 nm | 3.35 × 10⁻⁵ |
| Example 5 | 40% | Poor | 20.6 nm | Unmeasurable |

From Table 1 are obtained the following findings. Specifically, it is found that, in a case where the reactive diluent content is less than 10% by weight, the SER deteriorates, and, in a case where the reactive diluent content is more than 30% by weight, an uneven surface is caused on the hard coat 21 to increase the tracking error. Therefore, it is preferred that the reactive diluent content is in the range of from 10% to 30% by weight.

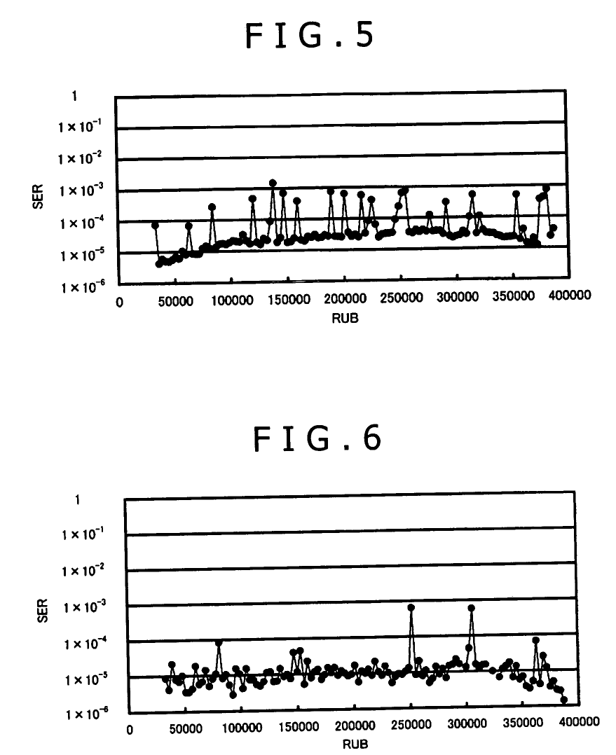

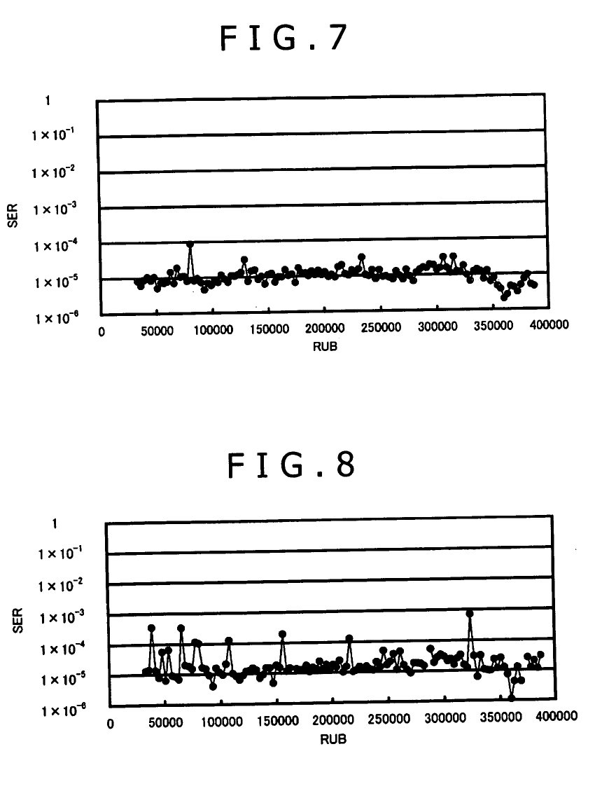

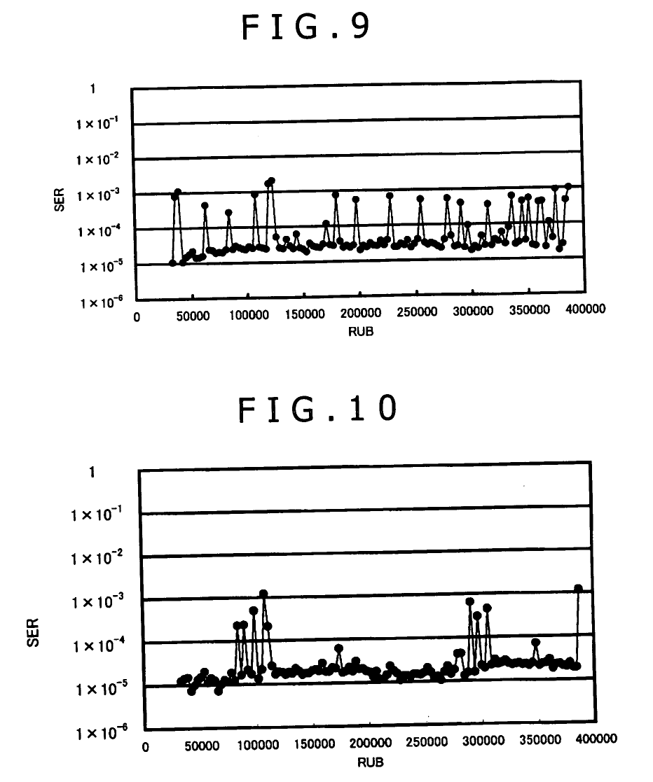

FIGS. 5 to 9 show the results of the evaluation of SER characteristics with respect to the optical discs 1 in Examples 1 to 4 and Comparative Example 1, respectively. In FIGS. 5 to 9, an SER is taken as the ordinate, and an RUB is taken as the abscissa. In Example 5, tracking could not be conducted due to the uneven surface of the hard coat 21, thus making the SER unmeasurable.

From FIGS. 5 to 9 are obtained the following findings. Specifically, it is found that, when the reactive diluent content is up to 20% by weight, the SER characteristics are improved as the reactive diluent content increases, and, when the reactive diluent content is more than 20% by weight, the SER characteristics are lowered.

[Evaluation of Water Contact Angle and Friction Coefficient]

Next, a water contact angle and a friction coefficient of the hard coat 21 were measured and evaluated.

### EXAMPLE 6

A reactive diluent was first added in an amount of 20% by weight based on the solids of a solvent-type hard coat agent to obtain a composition for hard coat having a solids content of 64.3% by weight. The solvent-type hard coat agent and reactive diluent used were the same as those used in Example 1.

Then, the above-obtained hard coat composition was uniformly applied to a substrate by a spin coating method without a stand-by time. In the spin coating, the number of revolutions was 5,000 rpm, and the spin time was 5 seconds. Subsequently, the uniformly applied hard coat composition was cured by ultraviolet light irradiation to obtain a hard coat 21.

### COMPARATIVE EXAMPLE 2

An optical disc 1 was obtained in substantially the same manner as in Example 6 except that a composition for hard coat which comprises solely the solvent-type hard coat agent was used.

### COMPARATIVE EXAMPLE 3

An optical disc 1 was obtained in substantially the same manner as in Example 6 except that a composition for hard coat which comprises solely the reactive diluent was used.

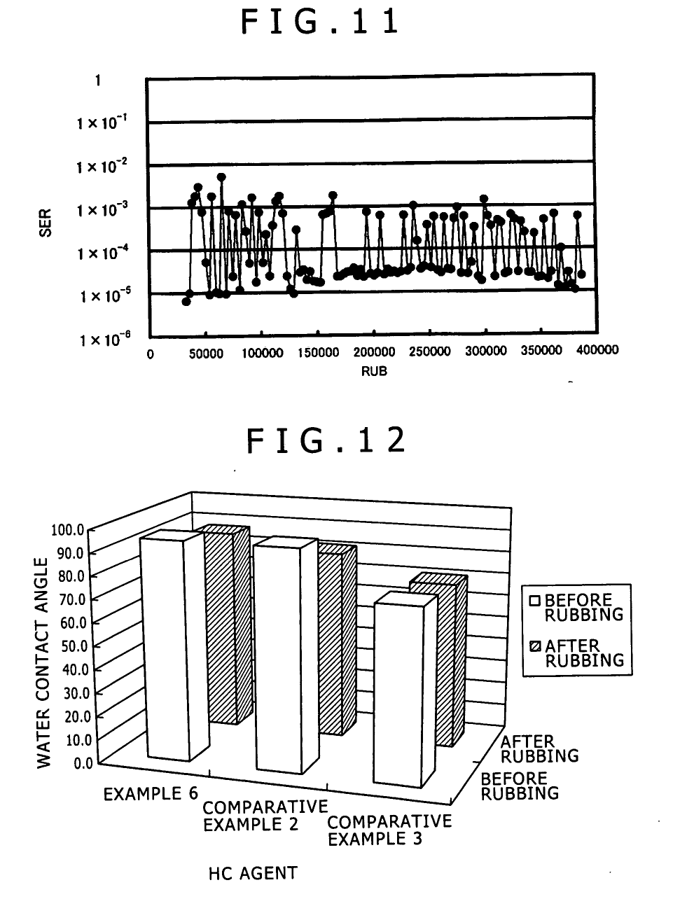

First, SER characteristics were evaluated with respect to Example 6 and Comparative Example 2. FIGS. 10 and 11 show the SER characteristics with respect to Example 6 and Comparative Example 2, respectively. From FIGS. 10 and 11 are obtained the following findings. Specifically, it is found that, in Comparative Example 2, a great number of noise peaks are found, whereas, in Example 6, almost no noise peak is present and the SER characteristics are considerably improved.

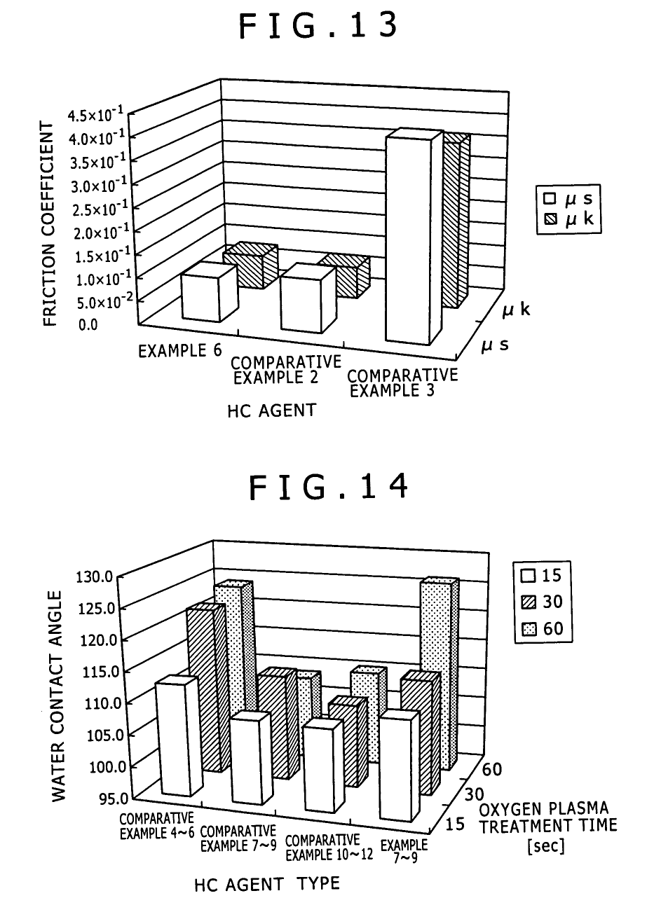

Next, the water contact angle and the coefficient of friction were evaluated with respect to Example 6 and Comparative Examples 2 and 3. FIG. 12 shows the results of the evaluation of water contact angle with respect to each of the optical discs 1 in Example 6 and Comparative Examples 2 and 3. FIG. 13 shows the results of the evaluation of friction coefficient with respect to each of the optical discs 1 in Example 6 and Comparative Examples 2 and 3. In FIG. 13, μs and μk designate a static friction coefficient and a dynamic friction coefficient, respectively.

From FIGS. 12 and 13 are obtained the following findings. Specifically, it is found that, in Comparative Example 3, the water contact angle is small and the friction coefficient is large, whereas, in Example 6 and Comparative Example 2, the water contact angle is large and the friction coefficient is small. In addition, it is found that the water contact angle and the friction coefficient in Example 6 are substantially the same as those in Comparative Example 2. In other words, it is found that the reactive diluent in a content as small as 20% does not largely affect the physical properties of the solvent-type hard coat agent.

[Examination of Stain-Proofing Treatment]

Next, an examination was made on the case where the hard coat 21 was stain-proofing-treated by successively stacking a coupling agent layer 22 and a stain-proofing layer 23 on the hard coat 21.

### EXAMPLE 7

A low molecular-weight reactive diluent was first added to a solvent-type hard coat agent, and then 2-methoxypropanol was added to obtain a composition for hard coat having a solids content of 60% by weight. The solvent-type hard coat agent and reactive diluent used were the same as those used in Example 1.

Then, the above-obtained hard coat composition was uniformly applied to a light transmitting layer 4 by a spin coating method without a stand-by time. In the spin coating, the number of revolutions was 5,000 rpm, and the spin time was 5 seconds. Subsequently, the uniformly applied hard coat composition was cured by ultraviolet light irradiation to obtain a hard coat 21.

Next, the optical disc 1 was placed in an oxygen plasma asher, and the asher was evacuated and the hard coat was subjected to oxygen plasma treatment for 15 seconds. Subsequently, the hard coat 21 was exposed to vapor of a coupling agent for 30 minutes to obtain a coupling agent layer 22. Then, a perfluoropolyether compound (stain-proofing agent) having alkoxysilane groups at the both ends thereof was synthesized. This compound was dissolved in satisfactorily dehydrated hydrofluoroether (H-GALDEN-ZV180, manufactured and sold by Ausimont, Inc.) so that the concentration became 0.4% by weight. The resultant solution was applied to the coupling agent layer 22 by a spin coating method, and dried overnight to obtain a stain-proofing layer 23. The optical disc 1 was obtained through the above steps.

### EXAMPLE 8

An optical disc 1 was obtained in substantially the same manner as in Example 7 except that the time for the oxygen plasma treatment was changed to 30 seconds.

### EXAMPLE 9

An optical disc 1 was obtained in substantially the same manner as in Example 7 except that the time for the oxygen plasma treatment was changed to 60 seconds.

### COMPARATIVE EXAMPLE 4

An optical disc 1 was obtained in substantially the same manner as in Example 7 except that a composition for hard coat which comprises solely the solvent-type hard coat agent was used.

### COMPARATIVE EXAMPLE 5

An optical disc 1 was obtained in substantially the same manner as in Comparative Example 4 except that the time for the oxygen plasma treatment was changed to 30 seconds.

### COMPARATIVE EXAMPLE 6

An optical disc 1 was obtained in substantially the same manner as in Comparative Example 4 except that the time for the oxygen plasma treatment was changed to 60 seconds.

### COMPARATIVE EXAMPLE 7

An optical disc 1 was obtained in substantially the same manner as in Example 7 except that 2-butoxypropanol was added to the solvent-type hard coat agent to obtain a composition for hard coat having a solids content of 60% by weight.

### COMPARATIVE EXAMPLE 8

An optical disc 1 was obtained in substantially the same manner as in Comparative Example 7 except that the time for the oxygen plasma treatment was changed to 30 seconds.

### COMPARATIVE EXAMPLE 9

An optical disc 1 was obtained in substantially the same manner as in Comparative Example 7 except that the time for the oxygen plasma treatment was changed to 60 seconds.

### COMPARATIVE EXAMPLE 10

An optical disc 1 was obtained in substantially the same manner as in Example 7 except that 2-butoxypropanol was added to the solvent-type hard coat agent, and 2-methoxypropanol as a low boiling-point component was evaporated under vacuum (40° C.) using an evaporator to obtain a composition for hard coat having a solids content of 60% by weight.

### COMPARATIVE EXAMPLE 11

An optical disc 1 was obtained in substantially the same manner as in Comparative Example 10 except that the time for the oxygen plasma treatment was changed to 30 seconds.

### COMPARATIVE EXAMPLE 12

An optical disc 1 was obtained in substantially the same manner as in Comparative Example 10 except that the time for the oxygen plasma treatment was changed to 60 seconds.

Next, a water contact angle was measured with respect to each of the optical discs 1 in Examples 7 to 9 and Comparative Examples 4 to 12. Subsequently, the optical discs 1 in Examples 7 to 9 and Comparative Examples 4 to 12 were individually subjected to ethanol rubbing, followed by measurement of a water contact angle.

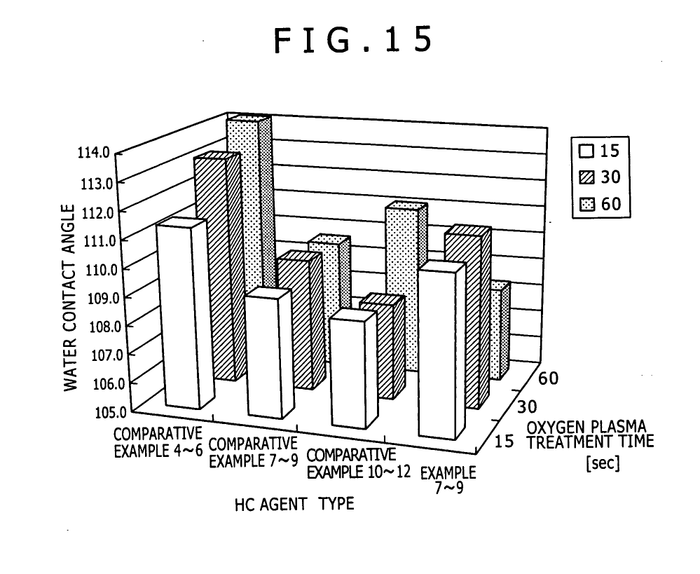

FIG. 14 shows the measurement results of water contact angle before the ethanol rubbing with respect to each of the optical discs 1 in Examples 7 to 9 and Comparative Examples 4 to 12. FIG. 15 shows the measurement results of water contact angle after the ethanol rubbing with respect to each of the optical discs 1 in Examples 7 to 9 and Comparative Examples 4 to 12.

From FIG. 14 are obtained the following findings. Specifically, it is found that, in Comparative Examples 7 to 12, the values of water contact angle are low, as compared to those in Comparative Examples 4 to 6, whereas, in Examples 7 to 9, the values of water contact angle are almost the same as those in Comparative Examples 4 to 6.

From FIG. 15 are obtained the following findings. Specifically, it is found that, in Examples 7 and 8 and Comparative Examples 4 to 12, the water contact angle is not markedly lowered after the ethanol rubbing, whereas, in Example 9, the water contact angle is drastically lowered after the ethanol rubbing.

From the above examinations, it is found that, in a case where the hard coat 21 is formed by adding 2-butoxypropanol to the solvent-type hard coat agent, the initial water contact angle is low. In addition, it is found that, in a case where the hard coat 21 is formed by adding the low molecular-weight reactive diluent to the solvent-type hard coat agent, there can be obtained an initial water contact angle substantially equivalent to that obtained in a case where the hard coat 21 is formed from solely the solvent-type hard coat agent, but a long-time oxygen plasma treatment lowers the mechanical strength, and hence an optimal time for the oxygen plasma treatment is present.

Hereinabove, the first and second embodiments of the present invention are described in detail, but the present invention is not limited to the first and second embodiments, and can be changed or modified on the basis of the technical concept of the present invention.

For example, the values shown above in the first and second embodiments are merely examples, and a value different from them may be used if necessary.

In the first and second embodiments, an example is shown in which the present invention is applied to the optical disc 1 such that recording and/or reproduction of an information signal is conducted by irradiating the disc with light from the side of the light transmitting layer 4, but the present invention is not limited to the optical disc having the above construction. For example, the present invention can be applied to an optical disc such that recording and/or reproduction of an information signal is conducted by irradiating the disc with light from the side of the substrate having light transmission properties (for example, CD (compact disc)), or an optical disc comprising substrates laminated together (for example, DVD (digital versatile disc)).

In the first and second embodiments, an example is shown in which the present invention is applied to the optical disc 1 having the information signal portion 3 comprised of a single layer, but the present invention may be applied to an optical disc having an information signal portion which comprises two layers or more.

In the first and second embodiments, an example is shown in which the light transmitting layer 4 comprises the bonding layer 11 and the light transmitting sheet 12, but the light transmitting layer 4 may comprises solely of an ultraviolet curable resin. In this case, as an example of the method for forming the light transmitting layer 4, there can be mentioned a spin coating method.

In the first and second embodiments, an example is shown in which the surface protecting film is formed on the optical disc 1, but the object on which the surface protecting film is formed is not limited to this. Examples of objects on which the surface protecting film is formed include an optical lens, an optical filter, an antireflection film, a liquid crystal display, a plasma display, and a touch panel.

In the first and second embodiments, the solvent-type hard coat agent may contain silica fine particles or a silane compound.

1. A composition for hard coat, comprising a solvent-type hard coat agent and a low molecular-weight reactive diluent added to the hard coat agent.

2. The composition for hard coat according to claim 1, wherein said reactive diluent contains a monomer.

3. The composition for hard coat according to claim 2, wherein said monomer is an acrylic monomer.

4. The composition for hard coat according to claim 1, wherein a content of said reactive diluent added to said composition is 10% to 30%.

5. A surface protecting film having a hard coat obtained by adding a low molecular-weight reactive diluent to a solvent-type hard coat agentand curing after coating.

6. The surface protecting film according to claim 5, wherein said reactive diluent contains a monomer.

7. The surface protecting film according to claim 6, wherein said monomer is an acrylic monomer.

8. The surface protecting film according to claim 5, wherein a content of said reactive diluent added to the composition is 10% to 30%.

9. The surface protecting film according to claim 5, wherein said solvent-type hard coat agent to which said reactive diluent is added is applied by a spin coating method.

10. The surface protecting film according to claim 5, wherein said solvent-type hard coat agent contains silica fine particles or a silane compound.

11. The surface protecting film according to claim 5, further comprising:
a coupling agent layer formed on said hard coat; and
a stain-proofing layer formed on said coupling agent layer.

12. The surface protecting film according to claim 11, wherein said coupling agent layer comprises a coupling agent which has a reactive group having an affinity with a material constituting said hard coat, and which has a reactive group having a bonding property to a material constituting said stain-proofing layer.

13. The surface protecting film according to claim 11, wherein said coupling agent layer is formed by exposure to vapor of a coupling agent.

14. The surface protecting film according to claim 11, wherein said coupling agent layer comprises a compound which has per one molecule two types of functional groups having different reactivity, and which is represented by the following general formula (1):
X—Rₐ—Si(OR_{b})₃ (1)
where X represents a reactive end group (a vinyl group, an epoxy group, an amino group, a methacrylic group, a mercapto group, or an isocyanate group), Rₐ represents an alkylene group, and R_{b} represents an alkyl group.

15. The surface protecting film according to claim 11, wherein said stain-proofing layer has at least one alkoxysilane group per one molecule.

16. The surface protecting film according to claim 15, wherein said stain-proofing layer comprises a perfluoropolyether compound having alkoxysilane groups at both ends thereof.

17. The surface protecting film according to claim 16, wherein said stain-proofing layer contains an alkoxysilane compound having a perfluoropolyether group and being represented by the following general formula (2):
(R³O)₃Si—R²—R¹CO—Rf—COR¹—R²—Si(OR³)₃ (2)
where Rf represents a perfluoropolyether group, R¹ represents any one of O, NH, and S, R² represents an alkylene group, and R³ represents an alkyl group.

18. The surface protecting film according to claim 15, wherein said stain-proofing layer contains an alkoxysilane compound having a perfluoropolyether group and being represented by the following general formula (3):
RfCOR¹—R²—Si(OR³)₃ (3)
where Rf represents a perfluoropolyether group, R¹ represents any one of O, NH, and S, R² represents an alkylene group, and R³ represents an alkyl group.

19. The surface protecting film according to claim 15, wherein said stain-proofing layer contains an alkoxysilane compound having a fluoroalkyl group and being represented by the following general formula (4):
Rf′—R¹—R²—Si(OR³)₃ (4)
where Rf′ represents a fluoroalkyl group, R¹ represents a divalent atom or atomic group, R² represents an alkylene group, and R³ represents an alkyl group.

20. The surface protecting film according to claim 15, wherein said stain-proofing layer contains an alkoxysilane compound having a fluoroalkyl group and being represented by the following general formula (5): [Chemical formula 5]
Rf′—R¹—Si—(OR²)₃ (5)
where Rf′ represents a fluoroalkyl group, R¹ represents an alkyl group having less than 7 carbon atoms, and R² represents an alkyl group.

21. An optical disc comprising:
an information signal portion formed on one principal surface of a substrate;
a protecting layer formed on said information signal portion; and
a surface protecting film formed on at least one surface selected from said protecting layer and said substrate,
wherein said surface protecting film has a hard coat obtained by adding a low molecular-weight reactive diluent to a solvent-type hard coat agent, and curing after coating.

22. The optical disc according to claim 21, wherein said reactive diluent contains a monomer.

23. The optical disc according to claim 22, wherein said monomer is an acrylic monomer.

24. The optical disc according to claim 21, wherein a content of said reactive diluent added to said composition is 10% to 30%.

25. The optical disc according to claim 21, wherein said solvent-type hard coat agent to which said reactive diluent is added is applied by a spin coating method.

26. The optical disc according to claim 21, wherein said solvent-type hard coat agent contains silica fine particles or a silane compound.

27. The optical disc according to claim 21, wherein said surface protecting film further comprises:
a coupling agent layer formed on said hard coat; and
a stain-proofing layer formed on said coupling agent layer.

28. The optical disc according to claim 27, wherein said coupling agent layer comprises a coupling agent which has a reactive group having an affinity with a material constituting said hard coat, and which has a reactive group having a bonding property to a material constituting said stain-proofing layer.

29. The optical disc according to claim 27, wherein said coupling agent layer is formed by exposure to vapor of a coupling agent.

30. The optical disc according to claim 27, wherein said coupling agent layer comprises a compound which has per one molecule two types of functional groups having different reactivity, and which is represented by the following general formula (1):
X—Rₐ—Si(OR_{b})₃ (1)
where X represents a reactive end group (a vinyl group, an epoxy group, an amino group, a methacrylic group, a mercapto group, or an isocyanate group), Rₐ represents an alkylene group, and R_{b} represents an alkyl group.

31. The optical disc according to claim 27, wherein said stain-proofing layer has at least one alkoxysilane group per one molecule.

32. The optical disc according to claim 31, wherein said stain-proofing layer comprises a perfluoropolyether compound having alkoxysilane groups at both ends thereof.

33. The optical disc according to claim 32, wherein said stain-proofing layer contains an alkoxysilane compound having a perfluoropolyether group and being represented by the following general formula (2):
(R³O)₃Si—R²—R¹CO—Rf—COR¹—R²—Si(OR³)₃ (2)
where Rf represents a perfluoropolyether group, R¹ represents any one of O, NH, and S, R² represents an alkylene group, and R³ represents an alkyl group.

34. The optical disc according to claim 31, wherein said stain-proofing layer contains an alkoxysilane compound having a perfluoropolyether group and being represented by the following general formula (3):
RfCOR¹—R²—Si(OR³)₃ (3)
wherein Rf represents a perfluoropolyether group, R¹ represents any one of O, NH, and S, R² represents an alkylene group, and R³ represents an alkyl group.

35. The optical disc according to claim 31, wherein said stain-proofing layer contains an alkoxysilane compound having a fluoroalkyl group and being represented by the following general formula (4):
Rf′—R¹—R²—Si(OR³)₃ (4)
where Rf′ represents a fluoroalkyl group, R¹ represents a divalent atom or atomic group, R² represents an alkylene group, and R³ represents an alkyl group.

36. The optical disc according to claim 31, wherein said stain-proofing layer contains an alkoxysilane compound having a fluoroalkyl group and being represented by the following general formula (5):
Rf′—R¹Si—(OR²)₃ (5)
where Rf′ represents a fluoroalkyl group, R¹ represents an alkyl group having less than 7 carbon atoms, and R² represents an alkyl group.
